(19) United States
(12) Patent Application Publication
(10) Pub. No.: US 2025/0384487 A1
(43) Pub. Date: Dec. 18, 2025

(54) SYSTEM AND METHOD FOR COMBINING MULTIPLE PRICING DATA SOURCES FOR ON-LINE BONDS TRADING

(71) Applicant: JPMorgan Chase Bank, N.A., New York, NY (US)

(72) Inventors: Leonidas TSEPENEKAS, College Park, MD (US); Sebastian TUDOR, Hoboken, NJ (US); Xiao HAN, Jericho, NY (US); Freddy LECUE, Mamaroneck, NY (US); Daniele MAGAZZENI, London (GB)

(73) Assignee: JPMorgan Chase Bank, N.A., New York, NY (US)

(21) Appl. No.: 18/750,670

(22) Filed: Jun. 21, 2024

(30) Foreign Application Priority Data
Jun. 14, 2024 (GR) 20240100440

(51) Int. Cl. G06Q 40/04

(52) U.S. Cl. CPC G06Q 40/04

(57) ABSTRACT

Various methods and processes, apparatuses or systems, and media for computing a fair market value of a bond are disclosed. A processor generates a table where all weight vector associated with a pricing prediction value of the bond at a given time received from a plurality of data sources are included therein; receives weight vector as input corresponding to the bond from the table; and computes a loss function for each of the plurality of data sources individually, wherein each loss function includes a first part and a second part, the first term indicates a distance very closer to a real value of the price at which the trade was executed compared to the second part which is a term that penalizes predictions for being further away from the real value; and computes a fair market value of the bond based on the loss function.

### CROSS-REFERENCE TO RELATED APPLICATIONS

This application claims the benefit of priority from Greek patent application Ser. No. 20240100440, filed Jun. 14, 2024, which is herein incorporated by reference in its entirety.

### TECHNICAL FIELD

This disclosure generally relates to data processing, and, more particularly, to methods and apparatuses for implementing a platform, language, cloud, and database agnostic pricing data sources combining module configured to combine multiple pricing data sources for on-line trading of bonds or other financial instruments.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Today, every modern organization appears to be drowning in data. It may prove to be a valuable asset that needs to be visible, understood, and trusted in order to drive an organization's profitability, innovation, and growth. For example, data related financial instruments play an important role in the modern society. A large number of financial instruments are issued and circulated every day to serve as proof of ownership or to facilitate monetary transactions or to increase one's financial portfolio. Each financial instrument is typically either a physical or virtual document having some monetary value and/or recording a monetary transaction. The most common examples of financial instruments may include cash instruments such as banknotes, stock certificates, bonds, checks, promissory notes, and certificates of deposit. More complex examples of financial instruments may include derivative instruments such as options, futures, swaps, and forwards which reference one or more underlying assets (e.g., asset classes of debt, equity, or foreign exchange).

A bond is a loan to a company or government that pays a fixed rate of return. Investors buy and sell bonds and other debt securities in the bond market. Investors, however, trade bonds for a number of reasons, with the key two being-profit and protection. Investors may profit by trading bonds to pick up yield (trading up to a higher-yielding bond) or benefit from a credit upgrade (bond price increases following an upgrade). Online trading may involve buying and selling stocks, bonds, commodities, currency pairs, cryptocurrencies, or other instruments through a trading platform or mobile app. The goal is to generate returns that outperform buy-and-hold investing. Online trading is a form of speculative investing.

For example, accurate price prediction may play an important role in speculative inventing. The more accurate the prediction the smaller the risk (the higher the profit). In online bond trading, it may prove to be very important to predict and compute fair market value of bonds for market making and trading purposes. In bidding, an investor may not want to buy a bond at a high price. In offering, an investor may not want to sell at a low price. Thus, it may be necessary to obtain data from a plurality of pricing data sources to compute fair market value of bonds. However, conventional online trading platforms lack configurations to integrate with a plurality of pricing data sources, thereby failing to compute fair market value of bonds or other financial instruments dynamically, accurately, and efficiently.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic pricing data sources combining module configured to combine multiple pricing data sources for computing fair market value of bonds or other financial instruments dynamically, accurately, and efficiently for market making and on-line trading purposes, but the disclosure is not limited thereto.

In some embodiments, a method for computing a fair market value of a bond by utilizing one or more processors along with allocated memory is disclosed. The method may include: establishing a communication link between a plurality of data sources and at least one processor via a communication interface, wherein each of said plurality of data sources provides a pricing prediction value of a bond at a given time; generating, by said at least one processor, a table where all weight vector associated with the pricing prediction value of the bond at the given time received from said plurality of data sources are included therein; receiving, by said at least one processor, weight vector as input corresponding to the bond from the table; computing, by said at least one processor, a loss function for each of said plurality of data sources individually, wherein each loss function includes a first part and a second part, wherein the first part is a term indicating a distance comparatively very close to a real trade value of the bond at the time when the trade was executed, and the second part indicates a profit and loss proxy that penalizes corresponding data source for being predicting a price for the bond that is comparatively very far to the real trade value of the bond at the time when the trade was executed; and computing, by said at least one processor, a fair market value of the bond based on the loss function.

In some embodiments, the method may include: generating a new weight vector for each pricing prediction value received from said plurality of data sources based on the loss function.

In some embodiments, the method may include: adjusting weights for next trade of the bond based on each of said new weight vector.

In some embodiments, the method may include: updating the table for next trade of the bond with the adjusted weights.

In some embodiments, in updating the table, the method may include: implementing a multiplicative weights update algorithm.

In some embodiments, the method may include: completing a trade of the bond based on the adjusted weights.

In some embodiments, the weights may indicate how important is the prediction of the data source in predicting a price for the bond.

In some embodiments, a system for computing a fair market value of a bond is disclosed. The system may include: a processor; and a memory operatively connected to the processor via a communication interface, the memory storing computer readable instructions, when executed, may cause the processor to: establish a communication link between a plurality of data sources and at least one processor via a communication interface, wherein each of said plurality of data sources provides a pricing prediction value of a bond at a given time; generate, by said at least one processor, a table where all weight vector associated with the pricing prediction value of the bond at the given time received from said plurality of data sources are included therein; receive, by said at least one processor, weight vector as input corresponding to the bond from the table; compute, by said at least one processor, a loss function for each of said plurality of data sources individually, wherein each loss function includes a first part and a second part, wherein the first part is a term indicating a distance comparatively very close to a real trade value of the bond at the time when the trade was executed, and the second part indicates a profit and loss proxy that penalizes corresponding data source for being predicting a price for the bond that is comparatively very far to the real trade value of the bond at the time when the trade was executed; and compute, by said at least one processor, a fair market value of the bond based on the loss function.

In some embodiments, the processor may be further configured to: generate a new weight vector for each pricing prediction value received from said plurality of data sources based on the loss function.

In some embodiments, the processor may be further configured to: adjust weights for next trade of the bond based on each of said new weight vector.

In some embodiments, the processor may be further configured to: update the table for next trade of the bond with the adjusted weights.

In some embodiments, in updating the table, the processor may be further configured to: implement a multiplicative weights update algorithm.

In some embodiments, the processor may be further configured to: complete a trade of the bond based on the adjusted weights.

In some embodiments, a non-transitory computer readable medium configured to store instructions for computing a fair market value of a bond is disclosed. The instructions, when executed, may cause a processor to perform the following: establishing a communication link between a plurality of data sources and at least one processor via a communication interface, wherein each of said plurality of data sources provides a pricing prediction value of a bond at a given time; generating, by said at least one processor, a table where all weight vector associated with the pricing prediction value of the bond at the given time received from said plurality of data sources are included therein; receiving, by said at least one processor, weight vector as input corresponding to the bond from the table; computing, by said at least one processor, a loss function for each of said plurality of data sources individually, wherein each loss function includes a first part and a second part, wherein the first part is a term indicating a distance comparatively very close to a real trade value of the bond at the time when the trade was executed, and the second part indicates a profit and loss proxy that penalizes corresponding data source for being predicting a price for the bond that is comparatively very far to the real trade value of the bond at the time when the trade was executed; and computing, by said at least one processor, a fair market value of the bond based on the loss function.

In some embodiments, the instructions, when executed, may cause the processor to further perform the following: generating a new weight vector for each pricing prediction value received from said plurality of data sources based on the loss function.

In some embodiments, the instructions, when executed, may cause the processor to further perform the following: adjusting weights for next trade of the bond based on each of said new weight vector.

In some embodiments, the instructions, when executed, may cause the processor to further perform the following: updating the table for next trade of the bond with the adjusted weights.

In some embodiments, in updating the table, the instructions, when executed, may cause the processor to further perform the following: implementing a multiplicative weights update algorithm.

In some embodiments, the instructions, when executed, may cause the processor to further perform the following: completing a trade of the bond based on the adjusted weights.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic pricing data sources combining module configured to combine multiple pricing data sources for computing fair market value of bonds or other financial instruments dynamically, accurately, and efficiently in accordance with an embodiment.

FIG. 2 illustrates an exemplary diagram of a network environment with a platform, language, database, and cloud agnostic pricing data sources combining device in accordance with an embodiment.

FIG. 3 illustrates a system diagram for implementing a platform, language, database, and cloud agnostic pricing data sources combining device having a platform, language, database, and cloud agnostic pricing data sources combining module in accordance with an embodiment.

FIG. 4 illustrates a system diagram for implementing a platform, language, database, and cloud agnostic pricing data sources combining module of FIG. 3 in accordance with an embodiment.

FIG. 5A illustrates an exemplary table listing all weights for all N bonds in a trading scope implemented by the platform, language, database, and cloud agnostic pricing data sources combining module of FIG. 4 in accordance with an embodiment.

FIG. 5B illustrates exemplary input for the platform, language, database, and cloud agnostic pricing data sources combining module of FIG. 4 in accordance with an embodiment.

FIG. 6 illustrates an exemplary flow chart of a process implemented by the platform, language, database, and cloud agnostic pricing data sources combining module of FIG. 4 for combining multiple pricing data sources for computing fair market value of bonds or other financial instruments dynamically, accurately, and efficiently in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

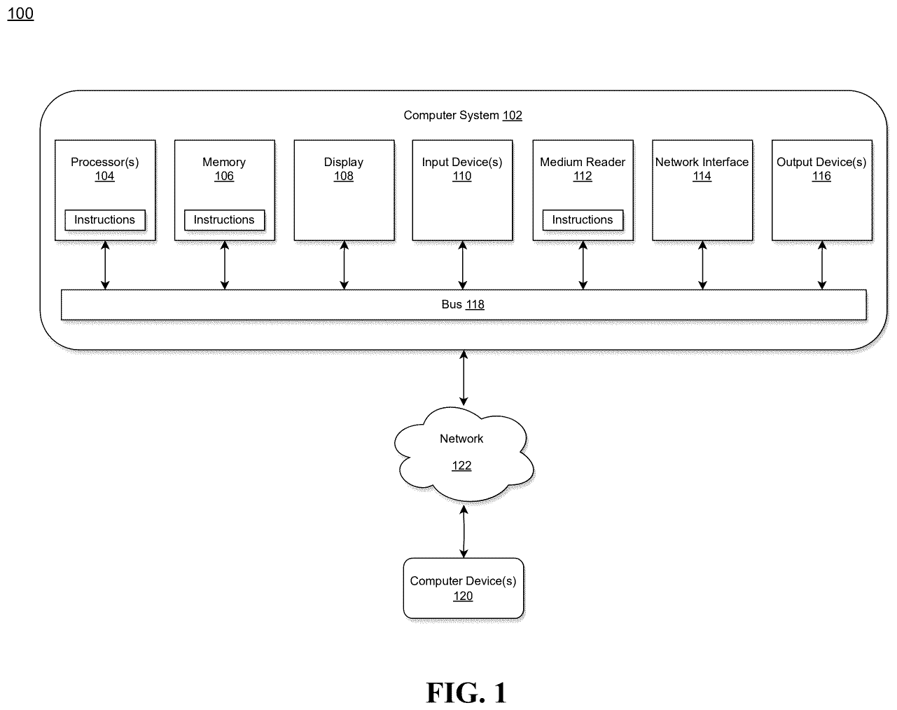

FIG. 1 is an exemplary system 100 for use in implementing a platform, language, database, and cloud agnostic pricing data sources combining module configured to combine module configured to combine multiple pricing data sources for computing fair market value of bonds or other financial instruments dynamically, accurately, and efficiently for market making and on-line trading purposes in accordance with an embodiment. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the pricing data sources combining module implemented by the system 100 may be platform, language, database, and cloud agnostic that may allow for consistent easy orchestration and passing of data through various components to output a desired result regardless of platform, browser, language, database, and cloud environment by writing programs accordingly. Since the disclosed process, in some embodiments, is platform, language, database, browser, and cloud agnostic, the pricing data sources combining module may be independently tuned or modified for optimal performance without affecting the configuration or data files. The configuration or data files, in some embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

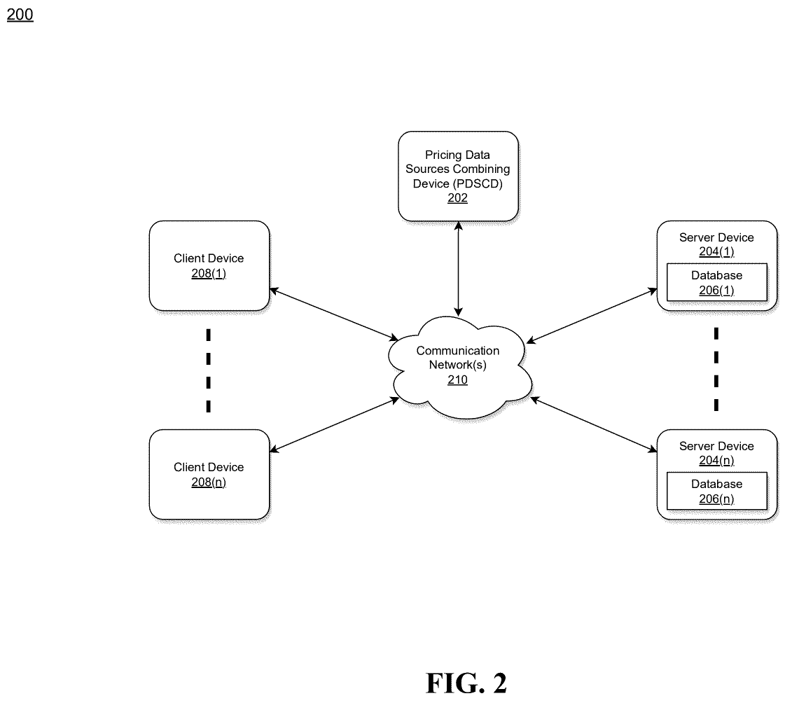

Referring to FIG. 2, a schematic of an exemplary network environment 200 for implementing a language, platform, database, and cloud agnostic pricing data sources combining device (PDSCD) of the instant disclosure is illustrated.

In some embodiments, the above-described problems associated with conventional tools may be overcome by implementing a PDSCD 202 as illustrated in FIG. 2 that may be configured for implementing a platform, language, database, and cloud agnostic pricing data sources combining module configured to combine multiple pricing data sources for computing fair market value of bonds or other financial instruments dynamically, accurately, and efficiently for market making and on-line trading purposes, but the disclosure is not limited thereto.

The PDSCD 202 may have one or more computer system 102s, as described with respect to FIG. 1, which in aggregate provide the necessary functions.

The PDSCD 202 may store one or more applications that can include executable instructions that, when executed by the PDSCD 202, cause the PDSCD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the PDSCD 202 itself, may be located in virtual server(s) running in a cloud-based computing environment rather than being tied to one or more specific physical network computing devices. Also, the application(s) may be running in one or more virtual machines (VMs) executing on the PDSCD 202. Additionally, in one or more embodiments of this technology, virtual machine(s) running on the PDSCD 202 may be managed or supervised by a hypervisor.

In the network environment 200 of FIG. 2, the PDSCD 202 is coupled to a plurality of server devices 204(1)-204(n) that hosts a plurality of databases 206(1)-206(n), and also to a plurality of client devices 208(1)-208(n) via communication network(s) 210. A communication interface of the PDSCD 202, such as the network interface 114 of the computer system 102 of FIG. 1, operatively couples and communicates between the PDSCD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PDSCD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The PDSCD 202 may be a standalone device or integrated with one or more other devices or apparatuses, such as one or more of the server devices 204(1)-204(n), for example. In one particular example, the PDSCD 202 may be hosted by one of the server devices 204(1)-204(n), and other arrangements are also possible. Moreover, one or more of the devices of the PDSCD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the PDSCD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the PDSCD 202 that may efficiently provide a platform for implementing a platform, language, database, and cloud agnostic pricing data sources combining module configured to combine multiple pricing data sources for computing fair market value of bonds or other financial instruments dynamically, accurately, and efficiently for market making and on-line trading purposes, but the disclosure is not limited thereto.

The client devices 208(1)-208(n) may run interface applications, such as standard web browsers or standalone client applications, which may provide an interface to communicate with the PDSCD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the PDSCD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the PDSCD 202, the server devices 204(1)-204(n), or the client devices 208(1)-208(n), for example, may be configured to operate as virtual instances on the same physical machine. For example, one or more of the PDSCD 202, the server devices 204(1)-204(n), or the client devices 208(1)-208(n) may operate on the same physical device rather than as separate devices communicating through communication network(s) 210. Additionally, there may be more or fewer PDSCDs 202, server devices 204(1)-204(n), or client devices 208(1)-208(n) than illustrated in FIG. 2. In some embodiments, the PDSCD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

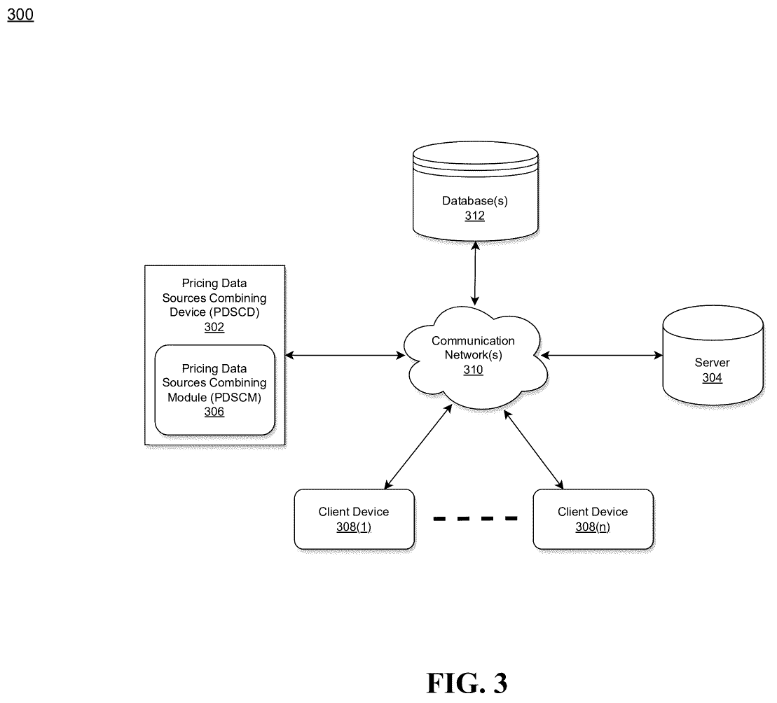

FIG. 3 illustrates a system diagram for implementing a platform, language, and cloud agnostic PDSCD having a platform, language, database, and cloud agnostic pricing data sources combining module (PDSCM) in accordance with an embodiment.

As illustrated in FIG. 3, the system 300 may include an PDSCD 302 within which an PDSCM 306 is embedded, a server 304, a database(s) 312, a plurality of client devices 308(1) . . . 308(n), and a communication network 310.

In some embodiments, the PDSCD 302 including the PDSCM 306 may be connected to the server 304, and the database(s) 312 via the communication network 310. The PDSCD 302 may also be connected to the plurality of client devices 308(1) . . . 308(n) via the communication network 310, but the disclosure is not limited thereto. The database(s) 312 may include rule database.

In an embodiment, the PDSCD 302 is described and shown in FIG. 3 as including the PDSCM 306, although it may include other rules, policies, modules, databases, or applications, for example. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the PDSCM 306 may be configured to receive real-time feed of data from the plurality of client devices 308(1) . . . 308(n) and secondary sources via the communication network 310.

As may be described below, the PDSCM 306 may be configured to: establish a communication link between a plurality of data sources and at least one processor via a communication interface, wherein each of said plurality of data sources provides a pricing prediction value of a bond at a given time; generate, by said at least one processor, a table where all weight vector associated with the pricing prediction value of the bond at the given time received from said plurality of data sources are included therein; receive, by said at least one processor, weight vector as input corresponding to the bond from the table; compute, by said at least one processor, a loss function for each of said plurality of data sources individually, wherein each loss function includes a first part and a second part, wherein the first part is a term indicating a distance comparatively very close to a real trade value of the bond at the time when the trade was executed, and the second part indicates a profit and loss proxy that penalizes corresponding data source for being predicting a price for the bond that is comparatively very far to the real trade value of the bond at the time when the trade was executed; and compute, by said at least one processor, a fair market value of the bond based on the loss function, but the disclosure is not limited thereto.

The plurality of client devices 308(1) . . . 308(n) are illustrated as being in communication with the PDSCD 302. In this regard, the plurality of client devices 308(1) . . . 308(n) may be “clients” (e.g., customers) of the PDSCD 302 and are described herein as such. Nevertheless, it is to be known and understood that the plurality of client devices 308(1) . . . 308(n) need not necessarily be “clients” of the PDSCD 302, or any entity described in association therewith herein. Any additional or alternative relationship may exist between either or both of the plurality of client devices 308(1) . . . 308(n) and the PDSCD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the PDSCD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The PDSCD 302 may be the same or similar to the PDSCD 202 as described with respect to FIG. 2, including any features or combination of features described with respect thereto.

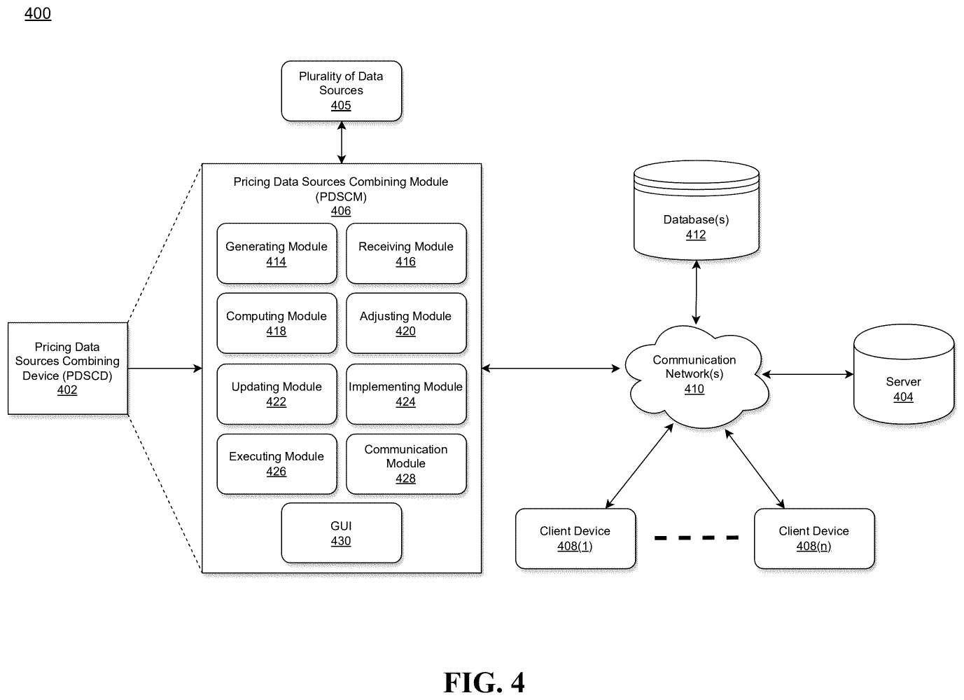

FIG. 4 illustrates a system diagram for implementing a platform, language, database, and cloud agnostic PDSCM of FIG. 3 in accordance with an embodiment.

In some embodiments, the system 400 may include a platform, language, database, and cloud agnostic PDSCD 402 within which a platform, language, database, and cloud agnostic PDSCM 406 is embedded, a server 404, a plurality of data sources 405, database(s) 412 that may store a table where all weight vector associated with the pricing prediction value of the bond at a given time received from the plurality of data sources 405 are included therein, and a communication network 410. In some embodiments, server 404 may comprise a plurality of servers located centrally or located in different locations, but the disclosure is not limited thereto.

In some embodiments, the PDSCD 402 including the PDSCM 406 may be connected to the server 404, the plurality of data sources 405, and the database(s) 412 via the communication network 410. The PDSCD 402 may also be connected to the plurality of client devices 408(1)-408(n) via the communication network 410, but the disclosure is not limited thereto. The PDSCM 406, the server 404, the plurality of client devices 408(1)-408(n), the database(s) 412, the communication network 410 as illustrated in FIG. 4 may be the same or similar to the PDSCM 306, the server 304, the plurality of client devices 308(1)-308(n), the database(s) 312, the communication network 310, respectively, as illustrated in FIG. 3.

In some embodiments, as illustrated in FIG. 4, the PDSCM 406 may include a generating module 414, a receiving module 416, a computing module 418, an adjusting module 420, an updating module 422, an implementing module 424, an executing module 426, a communication module 428, and a graphical user interface (GUI) 430. In some embodiments, interactions and data exchange among these modules included in the PDSCM 406 provide the advantageous effects of the disclosed invention. Functionalities of each module of FIG. 4 may be described in detail below with reference to FIGS. 4-6.

In some embodiments, each of the generating module 414, receiving module 416, computing module 418, adjusting module 420, updating module 422, implementing module 424, executing module 426, and the communication module 428 of the PDSCM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the generating module 414, receiving module 416, computing module 418, adjusting module 420, updating module 422, implementing module 424, executing module 426, and the communication module 428 of the PDSCM 406 of FIG. 4 may be implemented by microprocessors or similar, and may be programmed using software (e.g., microcode) to perform various functions discussed herein and may optionally be driven by firmware and/or software.

Alternatively, in some embodiments, each of the generating module 414, receiving module 416, computing module 418, adjusting module 420, updating module 422, implementing module 424, executing module 426, and the communication module 428 of the PDSCM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. For example, the PDSCM 406 of FIG. 4 may also be implemented by cloud based deployment.

In some embodiments, each of the generating module 414, receiving module 416, computing module 418, adjusting module 420, updating module 422, implementing module 424, executing module 426, and the communication module 428 of the PDSCM 406 of FIG. 4 may be called via corresponding API, but the disclosure is not limited thereto.

In some embodiments, the process implemented by the PDSCM 406 may be executed via the communication module 428 and the communication network 410, which may comprise plural networks as described above. For example, in an embodiment, the various components of the PDSCM 406 may communicate with the server 404, the plurality of data sources 405, and the database(s) 412 via the communication module 428 and the communication network 410 and the results tables with weights value, updated tables weights value, etc., may be displayed onto the GUI 430. Of course, these embodiments are merely exemplary and are not limiting or exhaustive. The database(s) 412 may include the databases included within the private cloud and/or public cloud and the server 404 may include one or more servers within the private cloud and the public cloud.

Details of the PDSCM 406 is provided below with corresponding modules that may be configured to combine the output from the plurality of data sources 405 for computing fair market value of bonds or other financial instruments dynamically, accurately, and efficiently for market making and on-line trading purposes.

Market making may refer broadly to trading strategies that seek to profit by providing liquidity to other traders, while avoiding accumulating a large net position in a stock or bond or other financial security interests. Typically, there are two types of transactions: Bid-RFQ (Request for Quote)—where one buys a bond that is on sale; and Offer-RFQ—where one tries to sell one of the bonds, he/she owns. Current market making desk may handle hundreds of thousands of RFQs daily, with a billon of trading volume. In electronic trading, a typical online platform may utilize a plurality of machine learning models to predict a fair market value of a bond. Output from these machine learning models are aggregated into one final price for execution.

However, the mixing of the sources is conventionally done in purely statistical and non-dynamic ways. To address the issues associated with conventional approach, the PDSCM 406 as disclosed herein may be configured to combine multiple pricing data sources for computing fair market value of bonds or other financial instruments dynamically, accurately, and efficiently for market making and on-line trading purposes by update the mixing weights over time, penalizing sources that are not performing well by implementing the following exemplary framework i)-v).

i) given N experts and a time horizon 1, . . . , T; ii) at each t expert i predicts yᵢ and the PDSCM 406 predicts

$${y}_{p} = \frac{{\sum }_{i} {w}_{i , t} \cdot {y}_{i}}{{\sum }_{i} {w}_{i , t}} ,$$

where w_{i,t} the weight of expert i at t; iii) the real value y is revealed (let's say the trace; value at which the trade was executed); iv) loss function [symbol] (y, yᵢ) captures how “wrong” the prediction yᵢ is; v)

$${w}_{i , t + 1} = {w}_{i , t} \cdot {e}^{- {η}_{t} \cdot ℓ ( y , {y}_{i} )}$$

(ηₜ is called the learning rate), but the disclosure is not limited thereto.

For example, the communication module 428 may be configured to establish a communication link between the plurality of data sources 405 and at least one processor 104 (i.e., as illustrated in FIG. 1; the processor may be embedded within the PDSCM 406). Each of said plurality of data sources 405 may provide a pricing prediction value of a bond at a given time.

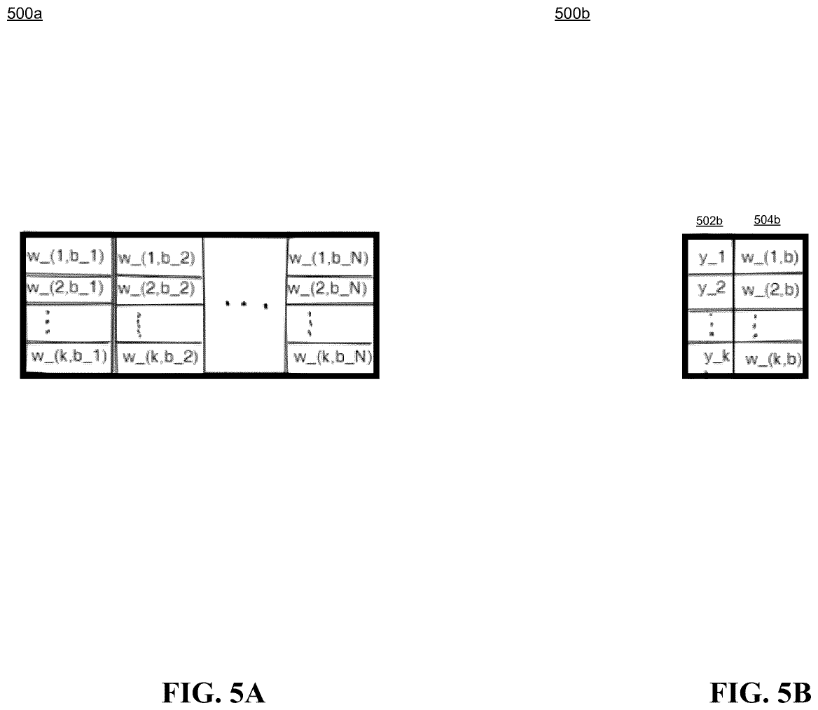

The generating module 414 may be configured to generate, a table where all weight vector associated with the pricing prediction value of the bond b at the given time received from the plurality of data sources 405 are included therein. For example, FIG. 5A illustrates an exemplary table 500a listing all weights for all N bonds in a trading scope implemented by the platform, language, database, and cloud agnostic PDSCM 406 of FIG. 4 in accordance with an embodiment. Initially all of those weights are 1. Typically, each bond may trade 1-300 times a day, but the disclosure is not limited thereto.

In some embodiments, the receiving module 416 may be configured to receive weight vector as input corresponding to the bond from the table 500a. FIG. 5B illustrates exemplary input 500b for the platform, language, database, and cloud agnostic PDSCM 406 of FIG. 4 in accordance with an embodiment. As illustrated in exemplary input 500b, element 502b indicates pricing sources access and element 504b indicates weight vector for bond b accessed from the table 500a.

In some embodiments, the computing module 418 may be configured to compute a loss function for each of plurality of data sources 405 (i.e., k sources) individually, wherein each loss function includes a first part and a second part, wherein the first part is a term indicating a distance comparatively very close to a real trade value of the bond at the time when the trade was executed, and the second part indicates a profit and loss proxy that penalizes corresponding data source for being predicting a price for the bond that is comparatively very far to the real trade value of the bond at the time when the trade was executed; and compute, by said at least one processor, a fair market value of the bond based on the loss function.

In some embodiments, the loss function computed by the computing module 418 of the PDSCM 406 as disclosed may prove to the most important function in computing fair market value of bonds. Conventional platforms as discussed above do not have configurations to compute such loss function, thereby fail to compute fair market value of bonds.

In some embodiments, the loss function computed by the PDSCM 406 may include the following:

$$ℓ ( y , {y}_{p} , s ) = {λ}_{1} \cdot \vert y - {y}_{p} \vert + {λ}_{2} \cdot max \{ 0 , sgn ( s ) \cdot ( {y}_{p} - y ) \}$$

where y is the trace (price at which the trade was executed), yₚ is the predicted price; s=1 (buy), and −1 (sell); λ₁, λ₂ are non-negative hyperparameters.

The PDSCM 406 may generate the following exemplary results: the loss function may be convex (necessary for the theoretical guarantees); these schemes may be robust to outliers (outliers are trades that do not occur near the fair market value); simulations: i) 0.72 cents increase per dollar traded, ii) 3% closer to the desirable hit rate.

Algorithm implemented by the PDSCM 406 may include the following, but the disclosure is not limited thereto.

For example, at each time step t there may be a trade for a specific bond, e.g., bond b. It is noted that in each time step t there may be a trade for only one bond. At time t, each of the k pricing sources (plurality of data sources 405) may predict a value y_i for the bond at hand, e.g., bond b. The PDSCM 406 may receive non-negative weights w_(i,b) for each source i. These weights show how important is the prediction of source i in predicting for bond b. The PDSCM 406 may implement a multiplicative weights update algorithm in predicting. At time t and for bond b that is being trade, the computed predictions by the PDSCM 406 may be:

$$y = ( w\_ ( 1 , b ) * y\_ 1 + w\_ ( 2 , b ) * y\_ 2 + … + w\_ ( k , b ) * y\_k ) / \text{} ( w\_ ( 1 , b ) + w\_ ( 2 , b ) + … + w\_ ( k , b ) ) .$$

The weights for the next time step (trade) may be updated by the PDSCM 406 based on a specific loss function computed by the PDSCM 406. For example, the weights for time t+1 are updated based on the loss function. In computing the specific loss function, the PDSCM 406 may implement the following algorithm.

Given a fixed time t and bond b traded at t. Let y be the TRACE value (price at which the trade was executed, i.e., the price after the trade is completed), and y_i the prediction of source i. If this is a sell trade, then the loss function is l_s(y,y_i)=a*|y−y_i|+b*max(0, y−y_i), where a, b are hyperparameters. If this is a buy trade, then the loss is l_b(y,y_i)=a*|y−y_i|+b*max(0, y_i−y), where a, b are hyperparameters. The first part of the loss function (i.e., a*|y−y_i| in the case of a sell trade; and also a*|y−y_i| in the case of a buy trade) captures the distance to the real trade value, and the second (i.e., b*max(0, y−y_i) in the case of a sell trade; and b*max(0, y_i−y) in the case of a buy trade) is a profit and loss proxy that penalizes being at the wrong side of the TRACE. When cover information is available, y is the cover and not the TRACE. The cover information is the second best bid in the trading process and gives a more robust way to measure profit and loss. As disclosed herein, the second part of the loss function forces the prediction to be on the right side of the real value. For example, in a buy scenario, an investor does not want to be below the actual buying price (loss of revenue). In some embodiments, the PDSCM 406 utilizes cover information when available.

To find optimal values for a, b, the PDSCM 406 may simulate the algorithm for predefined days (i.e., 40 days and performing a grid search).

In some embodiments, the generating module 414 may be further configured to generate a new weight vector for each pricing prediction value received from the plurality of data sources 405 based on the loss function. For example, in updating the weight w_i for trade t+1, the new weight may be w_i*e\hat{ }(−c*loss), where c may be a preconfigured constant value.

For example, the adjusting module 420 may be further configured to adjust weights for the next trade of the bond b based on each of the new weight vector. The updating module 422 may be configured to update the table 500a for next trade of the bond b with the adjusted weights. In updating the table, the implementing module 424 may be configured to implement a multiplicative weights update algorithm. And the executing module 426 may be configured to complete a trade of the bond b based on the adjusted weights at time t+1.

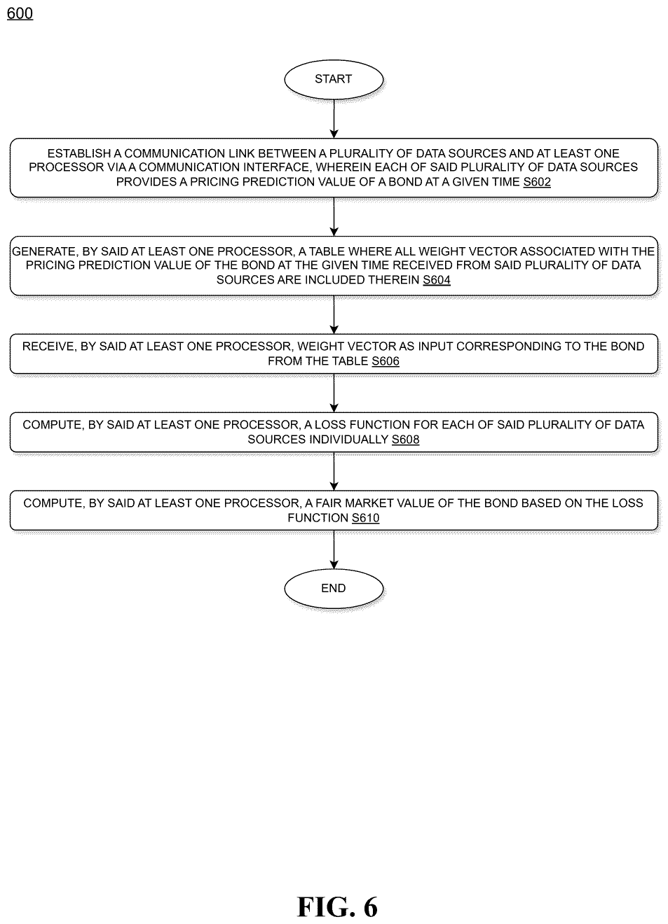

FIG. 6 illustrates an exemplary flow chart of a process 600 implemented by the platform, language, database, and cloud agnostic PDSCM 406 of FIG. 4 for combining multiple pricing data sources for computing fair market value of bonds or other financial instruments dynamically, accurately, and efficiently for market making and on-line trading purposes in accordance with an embodiment. It may be appreciated that the illustrated process 600 and associated steps may be performed in a different order, with illustrated steps omitted, with additional steps added, or with a combination of reordered, combined, omitted, or additional steps.

As illustrated in FIG. 6, at step S602, the process 600 may include establishing a communication link between a plurality of data sources and at least one processor via a communication interface. Each of the plurality of data sources may provide a pricing prediction value of a bond at a given time.

At step S604, the process 600 may include generating a table where all weight vector associated with the pricing prediction value of the bond at the given time received from said plurality of data sources are included therein.

At step S606, the process 600 may include receiving weight vector as input corresponding to the bond from the table.

At step S608, the process 600 may include computing a loss function for each of said plurality of data sources individually. Each loss function may include a first part and a second part, wherein the first part is a term indicating a distance comparatively very close to a real trade value of the bond at the time when the trade was executed, and the second part indicates a profit and loss proxy that penalizes corresponding data source for being predicting a price for the bond that is comparatively very far to the real trade value of the bond at the time when the trade was executed.

At step S610, the process 600 may include computing a fair market value of the bond based on the loss function.

In some embodiments, the process 600 may include: generating a new weight vector for each pricing prediction value received from said plurality of data sources based on the loss function.

In some embodiments, the process 600 may include: adjusting weights for next trade of the bond based on each of said new weight vector.

In some embodiments, the process 600 may include: updating the table for next trade of the bond with the adjusted weights.

In some embodiments, in updating the table, the process 600 may include: implementing a multiplicative weights update algorithm.

In some embodiments, the process 600 may include: completing a trade of the bond based on the adjusted weights.

In some embodiments, the weights may indicate how important is the prediction of the data source in predicting a price for the bond.

In some embodiments, the PDSCD 402 may include a memory (e.g., a memory 106 as illustrated in FIG. 1) which may be a non-transitory computer readable medium that may be configured to store instructions for implementing a platform, language, database, and cloud agnostic PDSCM 406 configured to combine multiple pricing data sources for computing fair market value of bonds or other financial instruments dynamically, accurately, and efficiently for market making and on-line trading purposes as disclosed herein. The PDSCD 402 may also include a medium reader (e.g., a medium reader 112 as illustrated in FIG. 1) which may be configured to read any one or more sets of instructions, e.g., software, from any of the memories described herein. The instructions, when executed by a processor embedded within the PDSCM 406 or within the PDSCD 402, may be used to perform one or more of the methods and processes as described herein. In a particular embodiment, the instructions may reside completely, or at least partially, within the memory 106, the medium reader 112, and/or the processor 104 (see FIG. 1) during execution by the PDSCD 402.

In some embodiments, the instructions, when executed, may cause a processor embedded within the PDSCM 406 or the PDSCD 402 to perform the following: establishing a communication link between a plurality of data sources and at least one processor via a communication interface, wherein each of said plurality of data sources provides a pricing prediction value of a bond at a given time; generating, by said at least one processor, a table where all weight vector associated with the pricing prediction value of the bond at the given time received from said plurality of data sources are included therein; receiving, by said at least one processor, weight vector as input corresponding to the bond from the table; computing, by said at least one processor, a loss function for each of said plurality of data sources individually, wherein each loss function includes a first part and a second part, wherein the first part is a term indicating a distance comparatively very close to a real trade value of the bond at the time when the trade was executed, and the second part indicates a profit and loss proxy that penalizes corresponding data source for being predicting a price for the bond that is comparatively very far to the real trade value of the bond at the time when the trade was executed; and computing, by said at least one processor, a fair market value of the bond based on the loss function, but the disclosure is not limited thereto. In some embodiments, the processor may be the same or similar to the processor 104 as illustrated in FIG. 1 or the processor embedded within the PDSCD 202, PDSCD 302, PDSCD 402, and PDSCM 406 which is the same or similar to the processor 104.

In some embodiments, the instructions, when executed, may cause the processor 104 to further perform the following: generating a new weight vector for each pricing prediction value received from said plurality of data sources based on the loss function.

In some embodiments, the instructions, when executed, may cause the processor 104 to further perform the following: adjusting weights for next trade of the bond based on each of said new weight vector.

In some embodiments, the instructions, when executed, may cause the processor 104 to further perform the following: updating the table for next trade of the bond with the adjusted weights.

In some embodiments, in updating the table, the instructions, when executed, may cause the processor 104 to further perform the following: implementing a multiplicative weights update algorithm.

In some embodiments, the instructions, when executed, may cause the processor 104 to further perform the following: completing a trade of the bond based on the adjusted weights.

In some embodiments as disclosed above in FIGS. 1-6, technical improvements effected by the instant disclosure may include a platform for implementing a platform, language, database, and cloud agnostic pricing data sources combining module configured to combine multiple pricing data sources for computing fair market value of bonds or other financial instruments dynamically, accurately, and efficiently for market making and on-line trading purposes, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for computing a fair market value of a bond by utilizing one or more processors along with allocated memory, the method comprising:
establishing a communication link between a plurality of data sources and at least one processor via a communication interface, wherein each of said plurality of data sources provides a pricing prediction value of a bond at a given time;
generating, by said at least one processor, a table where all weight vector associated with the pricing prediction value of the bond at the given time received from said plurality of data sources are included therein;
receiving, by said at least one processor, weight vector as input corresponding to the bond from the table;
computing, by said at least one processor, a loss function for each of said plurality of data sources individually, wherein each loss function includes a first part and a second part, wherein the first part is a term indicating a distance comparatively very close to a real trade value of the bond at the time when the trade was executed, and the second part indicates a profit and loss proxy that penalizes corresponding data source for being predicting a price for the bond that is comparatively very far to the real trade value of the bond at the time when the trade was executed; and
computing, by said at least one processor, a fair market value of the bond based on the loss function.

2. The method according to claim 1, further comprising:
generating a new weight vector for each pricing prediction value received from said plurality of data sources based on the loss function.

3. The method according to claim 2, further comprising:
adjusting weights for next trade of the bond based on each of said new weight vector.

4. The method according to claim 3, further comprising:
updating the table for next trade of the bond with the adjusted weights.

5. The method according to claim 4, in updating the table, the method further comprising:
implementing a multiplicative weights update algorithm.

6. The method according to claim 5, further comprising:
completing a trade of the bond based on the adjusted weights.

7. The method according to claim 2, wherein the weights indicate how important is the prediction of the data source in predicting a price for the bond.

8. A system for computing a fair market value of a bond, the system comprising:
a processor; and
a memory operatively connected to the processor via a communication interface, the memory storing computer readable instructions, when executed, causes the processor to:
establish a communication link between a plurality of data sources and at least one processor via a communication interface, wherein each of said plurality of data sources provides a pricing prediction value of a bond at a given time;
generate, by said at least one processor, a table where all weight vector associated with the pricing prediction value of the bond at the given time received from said plurality of data sources are included therein;
receive, by said at least one processor, weight vector as input corresponding to the bond from the table;
compute, by said at least one processor, a loss function for each of said plurality of data sources individually, wherein each loss function includes a first part and a second part, wherein the first part is a term indicating a distance comparatively very close to a real trade value of the bond at the time when the trade was executed, and the second part indicates a profit and loss proxy that penalizes corresponding data source for being predicting a price for the bond that is comparatively very far to the real trade value of the bond at the time when the trade was executed; and
compute, by said at least one processor, a fair market value of the bond based on the loss function.

9. The system according to claim 8, wherein the processor is further configured to:
generate a new weight vector for each pricing prediction value received from said plurality of data sources based on the loss function.

10. The system according to claim 9, wherein the processor is further configured to:
adjust weights for next trade of the bond based on each of said new weight vector.

11. The system according to claim 10, wherein the processor is further configured to:
update the table for next trade of the bond with the adjusted weights.

12. The system according to claim 11, in updating the table, the processor is further configured to:
implement a multiplicative weights update algorithm.

13. The system according to claim 12, wherein the processor is further configured to:
complete a trade of the bond based on the adjusted weights.

14. The system according to claim 9, wherein the weights indicate how important is the prediction of the data source in predicting a price for the bond.

15. A non-transitory computer readable medium configured to store instructions for computing a fair market value of a bond, the instructions, when executed, cause a processor to perform the following:
establishing a communication link between a plurality of data sources and at least one processor via a communication interface, wherein each of said plurality of data sources provides a pricing prediction value of a bond at a given time;
generating, by said at least one processor, a table where all weight vector associated with the pricing prediction value of the bond at the given time received from said plurality of data sources are included therein;
receiving, by said at least one processor, weight vector as input corresponding to the bond from the table;
computing, by said at least one processor, a loss function for each of said plurality of data sources individually, wherein each loss function includes a first part and a second part, wherein the first part is a term indicating a distance comparatively very close to a real trade value of the bond at the time when the trade was executed, and the second part indicates a profit and loss proxy that penalizes corresponding data source for being predicting a price for the bond that is comparatively very far to the real trade value of the bond at the time when the trade was executed; and
computing, by said at least one processor, a fair market value of the bond based on the loss function.

16. The non-transitory computer readable medium according to claim 15, wherein the instructions, when executed, cause the processor to further perform the following:
generating a new weight vector for each pricing prediction value received from said plurality of data sources based on the loss function.

17. The non-transitory computer readable medium according to claim 16, wherein the instructions, when executed, cause the processor to further perform the following:
adjusting weights for next trade of the bond based on each of said new weight vector.

18. The non-transitory computer readable medium according to claim 17, wherein the instructions, when executed, cause the processor to further perform the following:
updating the table for next trade of the bond with the adjusted weights.

19. The non-transitory computer readable medium according to claim 18, in updating the table, the instructions, when executed, cause the processor to further perform the following:
implementing a multiplicative weights update algorithm.

20. The non-transitory computer readable medium according to claim 19, wherein the instructions, when executed, cause the processor to further perform the following:
completing a trade of the bond based on the adjusted weights.
